(19) United States
(12) Patent Application Publication
(10) Pub. No.: US 2022/0142123 A1
(43) Pub. Date: May 12, 2022

(54) ANIMAL TOY DEVICE AND METHOD OF USE

(71) Applicant: Joe Fortino, Laguna Niguel, CA (US)

(72) Inventor: Joe Fortino, Laguna Niguel, CA (US)

(21) Appl. No.: 17/520,801

(22) Filed: Nov. 8, 2021

Related U.S. Application Data
(60) Provisional application No. 63/111,130, filed on Nov. 9, 2020.

(51) Int. Cl. A01K 15/02

(52) U.S. Cl. CPC A01K 15/025

(57) ABSTRACT

This disclosure relates to an animal toy device and method of use. More specifically and without limitation, this disclosure relates to an animal toy to be used by dogs, cats, and other animals and/or pets. This disclosure relates to an animal toy which can easily clip to and/or be carried by the animal. Further features and functionality disclosed herein.

### CROSS-REFERENCE TO RELATED APPLICATIONS

The present application claims priority to the U.S. Provisional Patent Application No. 63/111,130 which was filed on Nov. 9, 2020, which is hereby incorporated by reference herein in its entirety, including any figures, tables, or drawings.

### FIELD OF THE DISCLOSURE

This disclosure relates to an animal toy device and method of use. More specifically and without limitation, this disclosure relates to an animal toy to be used by dogs, cats, and other animals and/or pets. Furthermore, and without limitation, this disclosure relates to an animal toy which can easily clip to and/or be carried by the animal.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright JollyLoves LLC. All rights reserved.

### BACKGROUND OF THE DISCLOSURE

Animal toys, and dog toys, for example, are well known in the art. A dog toy, by example, is a toy that is specifically for domesticated and/or other dogs to play with. In this way, animal toys are toys designed to be engaged with and/or played with by animals. Animal toys are often specifically designed for engagement and/or durability; the designs of which vary greatly depending on the type of animal the toy is intended for. Additionally, dog toys may be training aids and/or health devices designed to help an animal exercise physical activity and/or engage its senses so the animal can stay stimulated, and the like.

Animal toys have many purposes and/or benefits. Some of these benefits include aiding in the dental health of animals, as animals need to chew on toys and/or interact with toys so that they can clean their teeth and gums. Additionally, the exercise from interaction often causes jaw movement and increased jaw health as a minimum. Furthermore, exercise is often induced which increases the physical overall health of an animal. In this way exercise often stimulates animal minds and senses, to discourage stress, boredom, excess energy, and the like. In this way, animal toys provide a variety of health benefits for various animals and the like.

There are a wide variety of toys and or devices which exist today. Some examples of these toys might include large human sized, inflatable balls for whales, to small wheels for hamsters and/or other rodents. Size of a toy depends on the animal, the activity, and the play style.

Animal toys are often small, get lost, and get left behind. Additionally, animal toys often get dirty by picking up debris and the like. Animals tend not to keep track of their toys and or carry their toys to various locations for use and/or remember to bring their toys when departing a particular location. Furthermore, some animal toys are not safe for animal use or present potential health problems. By one example, a dog playing with a stick or an unsafe object can cause dental problems, punctures to the mouth, digestive issues, or potentially cause fatal implications for animals.

Therefore, there is a need in the art for an animal play apparatus that is safe, clean, and will not be left behind, unattended and/or forgotten by an animal and/or owner of an animal.

### SUMMARY OF THE DISCLOSURE

An animal toy apparatus and method of use is presented having an animal toy apparatus, and a method of use. More specifically and without limitation, this disclosure relates to an animal toy device and method of use. More specifically and without limitation, this disclosure relates to an animal toy to be used by dogs, cats, and other animals and/or pets. Furthermore, and without limitation, this disclosure relates to an animal toy which can easily clip to and/or be carried by the animal. Furthermore, this disclosure relates to a safe animal toy device which is clean and easy to store.

Therefore, it is a primary purpose of the disclosure herein to present a convenient, clean, and safe to use animal toy apparatus and method of use.

Thus, it is a primary object of the disclosure to provide an animal toy apparatus and method of use that improves upon the state of the art.

Another object of the disclosure is to provide an animal toy device and method of use that is safe to use.

Yet another object of the disclosure is to provide an animal toy device and method of use that is easy to use.

Another object of the disclosure is to provide an animal toy device and method of use that can be used by a variety of animals.

Yet another object of the disclosure is to provide an animal toy device and method of use that can be implemented by a variety of users.

Another object of the disclosure is to provide an animal toy device and method of use that is quick to apply as a method of use.

Yet another object of the disclosure is to provide an animal toy device and method of use that is convenient.

Another object of the disclosure is to provide an animal toy device and method of use that is easy to store.

Yet another object of the disclosure is to provide an animal toy device and method of use that can be transported on an animal.

Another object of the disclosure is to provide an animal toy device and method of use that can be stored on an animal.

Yet another object of the disclosure is to provide an animal toy device and method of use that is durable.

Another object of the disclosure is to provide an animal toy device and method of use that provides a plurality of attachments means.

Yet another object of the disclosure is to provide an animal toy device and method of use that is high quality.

Another object of the disclosure is to provide an animal toy device and method of use that can be quickly attached.

Yet another object of the disclosure is to provide an animal toy device and method of use that can be quickly dispatched.

Another object of the disclosure is to provide an animal toy device and method of use that provides cleanliness and health safety.

Yet another object of the disclosure is to provide an animal toy device and method of use that can be tracked by a global positioning satellite (GPS).

Another object of the disclosure is to provide an animal toy device and method of use that communicates level of use to an owner and/or user.

Yet another object of the disclosure is to provide an animal toy device and method of use that increases the quality of life of an animal.

Another object of the disclosure is to provide an animal toy device and method of use that is lightweight.

Yet another object of the disclosure is to provide an animal toy device and method of use that can be worn at all times.

Another object of the disclosure is to provide an animal toy device and method of use that aids in the health of an animal.

Yet another object of the disclosure is to provide an animal toy device and method of use that prevents toy loss.

Another object of the disclosure is to provide an animal toy device and method of use that provides for improved dental health of an animal.

Yet another object of the disclosure is to provide an animal toy device and method of use that is bluetooth capable.

These and other objects, features, or advantages of the present disclosure will become apparent from the specification and claims.

### BRIEF DESCRIPTION OF THE DRAWINGS

FIG. 1 is a front, perspective view showing the animal toy device; the view showing an engagement device; the view showing a ball as the engagement device; the view showing an attachment feature; the view showing a rope; the view showing an attachment feature securing the rope to the engagement device.

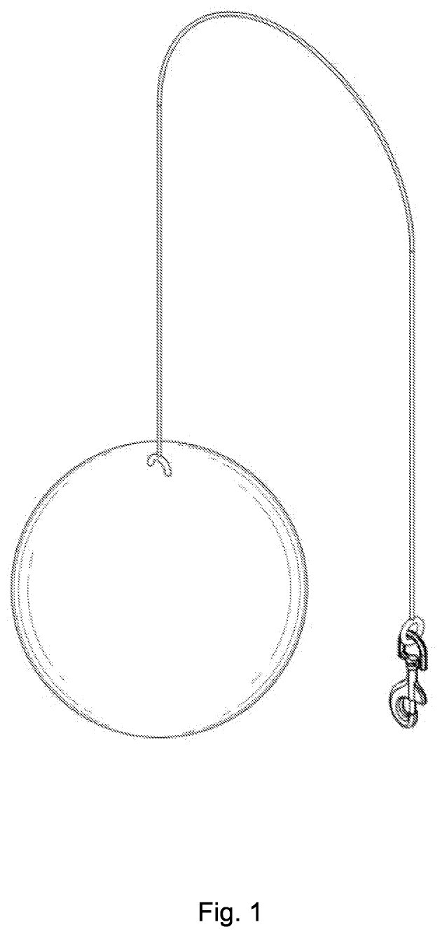

FIG. 2 is a rear, perspective view showing the animal toy device; the view showing an engagement device; the view showing a ball as the engagement device; the view showing an attachment feature; the view showing a rope; the view showing an attachment feature securing the rope to the engagement device.

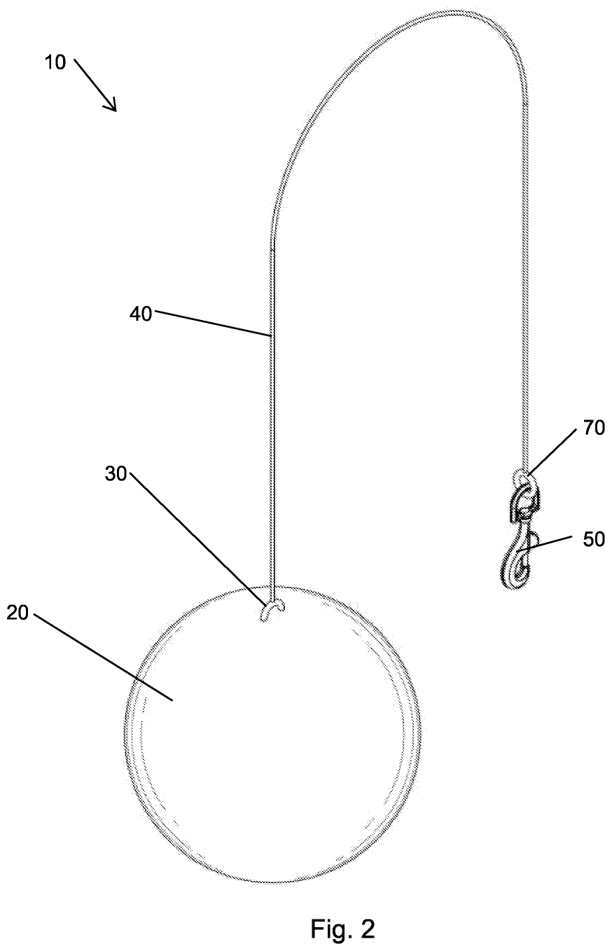

FIG. 3 is a top view showing the animal toy device; the view showing an engagement device; the view showing a ball as the engagement device; the view showing an attachment feature; the view showing a rope; the view showing an attachment feature securing the rope to the engagement device.

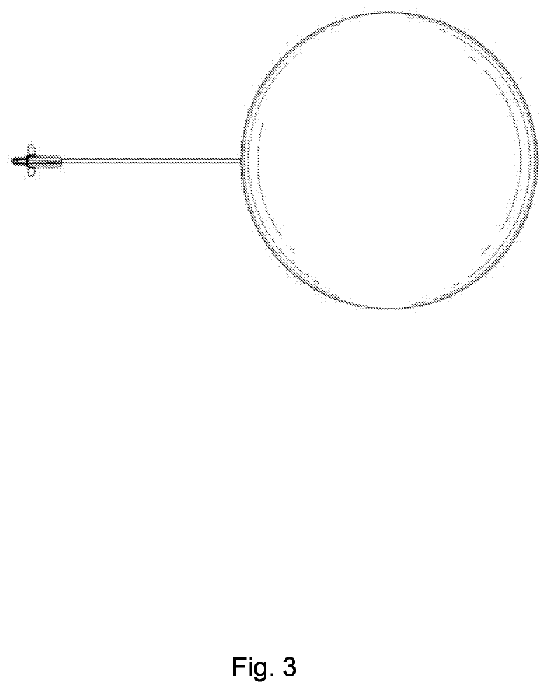

FIG. 4 is a bottom view showing the animal toy device; the view showing an engagement device; the view showing a ball as the engagement device; the view showing an attachment feature; the view showing a rope; the view showing an attachment feature securing the rope to the engagement device.

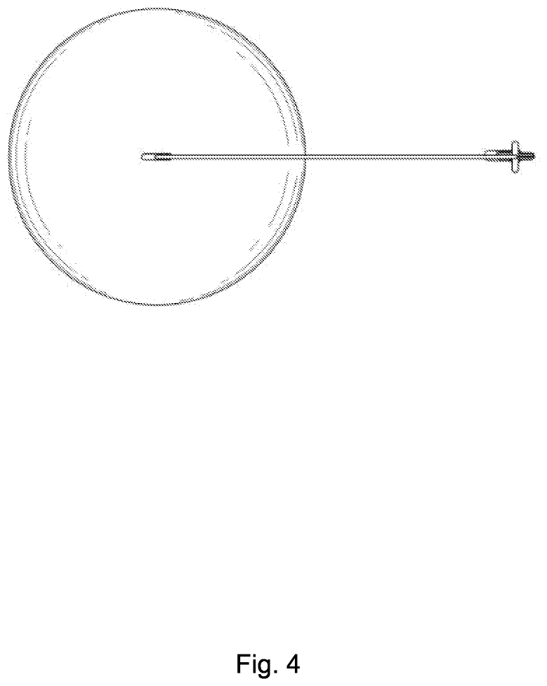

FIG. 5 is a front view showing the animal toy device; the view showing an engagement device; the view showing a ball as the engagement device; the view showing an attachment feature; the view showing a rope; the view showing an attachment feature securing the rope to the engagement device.

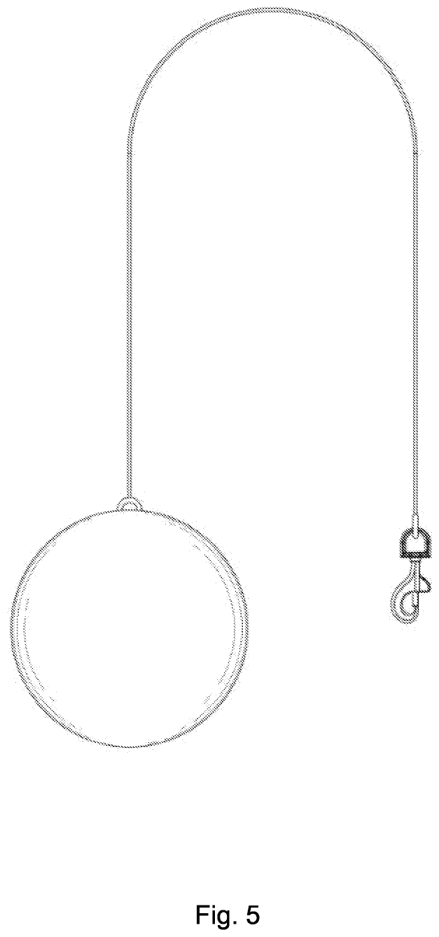

FIG. 6 is a rear view showing the animal toy device; the view showing an engagement device; the view showing a ball as the engagement device; the view showing an attachment feature; the view showing a rope; the view showing an attachment feature securing the rope to the engagement device.

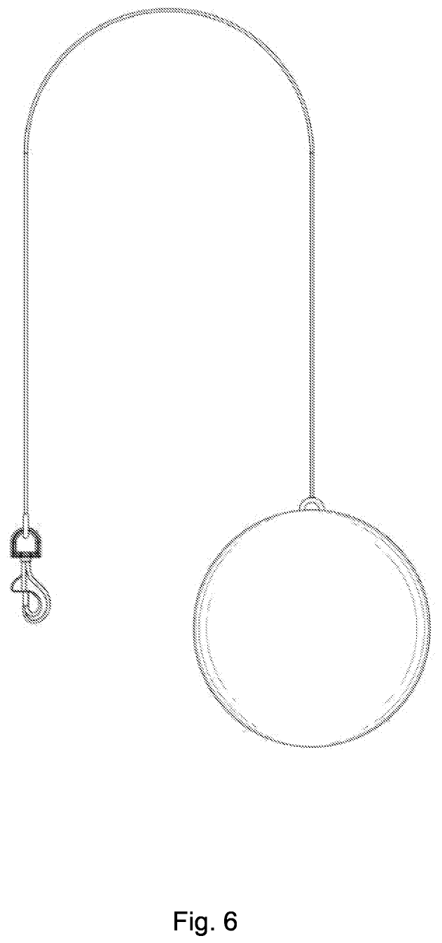

FIG. 7 is a side view showing the animal toy device; the view showing an engagement device; the view showing a ball as the engagement device; the view showing an attachment feature; the view showing a rope; the view showing an attachment feature securing the rope to the engagement device.

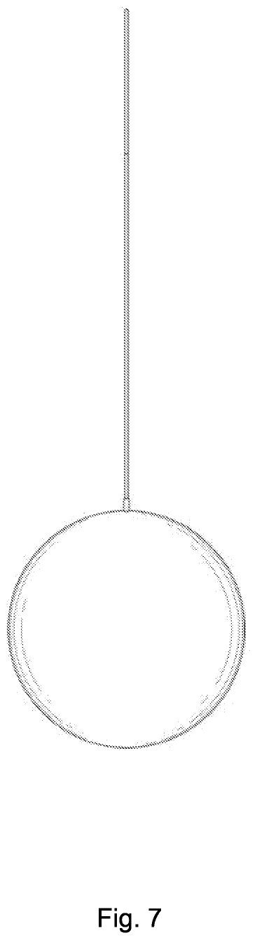

FIG. 8 is a side view showing the animal toy device; the view showing an engagement device; the view showing a ball as the engagement device; the view showing an attachment feature; the view showing a rope; the view showing an attachment feature securing the rope to the engagement device.

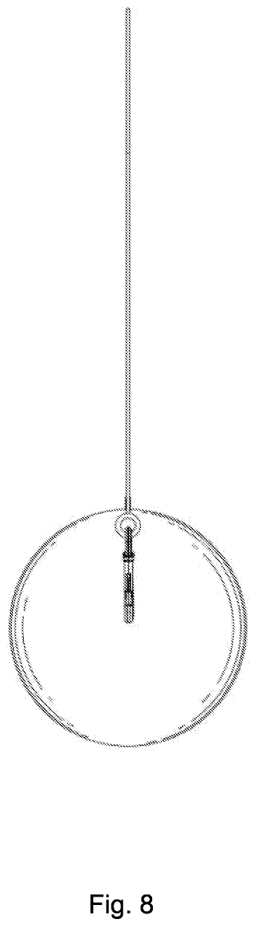

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

With reference to the figures, a system and/or animal toy apparatus and method of use is presented. The system provides a system for attaching an animal toy to the animal. In the example of a dog, the system presents a unique way such that an animal can carry their own toys. In one example, as an explanation, a toy apparatus is attached to a securing device which can secure the toy to the collar and/or harness and/or other item located on the animal. In this way, the animal can carry their own toy and the toy can be easily removed and or re-attached. In this way, cleanliness and convenience of a user is greatly improved. Also in this way, an animal is encouraged to use toys and/or engage with environments which are safer to use.

### System

With reference to the figures, an animal toy device system and method of use, system 10 (also known as “system”, “animal toy system”, “toy apparatus”, “animal toy device”, and “animal toy apparatus”) are presented. System 10, as presented herein, discloses an animal toy device which can be conveniently attached to an animal and a method of using the device. Additionally, as will become apparent in the disclosure herein, system 10 discloses a variety of other uses and applications. System 10 is formed of any suitable size, shape, and design and is configured to provide the safe and effective toy system for an animal which is convenient and easy to use.

In the arrangement shown, as one example, system 10 includes an animal toy 20, a first attachment feature 30, an extension device 40, a second attachment feature 50, and may also include a collar and/or harness 60, and may also include other attachment devices 70—such as a dog bowl attachment device, a food pouch, a carry case, and the like—and may also include bluetooth and/or GPS features, among other features, functionalities, and components.

### Ball/Toy

In the arrangement shown as one example, system 10 includes a ball and/or animal toy 20. Animal toy 20 (or “dog toy”, or “chew toy”, or “ball”) may be formed of any suitable size, shape, and design and is configured as the primary interaction device which an animal engages with. In the example of a dog, a dog toy 20 is implemented.

In this arrangement, and as is shown in one example, the dog toy 20 is a ball and/or tennis ball. In this way, the dog toy is a toy in which a dog would interact with. In this way, a human and/or user can throw the ball, to be retrieved by the animal, the animal and/or dog can chew on the ball and the like.

In the arrangement shown, as one example, the dog toy 20 is attached to the first attachment feature 30 (first attachment feature 30 to be further discussed herein). In this way, the dog toy 20 can be carried by a dog and/or other animal.

While a dog toy 20, or more specifically a ball, is considered herein by example, animal toy 20 may be formed of any toy and/or device. In this way, animal toy 20 may be formed of any size, depending on the animal, any type, of varying durabilities, and the like. Some examples of a dog toy include a chewable toy, a stuffed animal, a stuffed feature, a frisbee, a chewable, a consumable, a bone, a ball, any combination thereof, and the like.

### First Attachment Feature

In the arrangement shown as one example, system 10 includes a first attachment feature 30. First attachment feature 30 (or “toy attachment feature”) may be formed of any suitable size, shape, and design and is configured to attach the animal toy 20 to the extension device 40 (to be further discussed herein) and/or to the animal itself, often by means of a collar or harness.

In the arrangement shown, as one example, the first attachment feature 30 includes a plurality of loops which are permanently attached to one another. In this way, the loops are permanently attached, such that the loops permanently affix the animal toy 20 to the extension device 40.

In the arrangement shown, as one example, the first attachment feature 30 is formed of a string and/or fabric which is looped to secure the animal toy 20 to the extension device 40 and/or another device such as a collar and/or harness. However, the first attachment feature may also be detachable from the extension device 40. In this way, and in this example, the first attachment feature 30 may be formed of varying materials and devices. Varying materials and devices for the formation of the first attachment feature 30 includes both permanent and temporary attachment mechanisms, but are not limited to, hook and loop and buckle configurations, a spring clip, a knot, a clip, a magnet, a coupling, a lobster claw, an egg hook, a key clip, a spring hook, a carbine buckle, a gate snap hook, a swivel hook, a badge clip, a plastic hook, a carabiner, a reel clip, a badge reel, a swivel buckle, a safety buckle, an adjustable buckle, a key ring, any combination thereof, and the like.

### Extension Device

In the arrangement shown as one example, system 10 includes an extension device 40. Extension device 40 (or “string”, or “rope”, or “line”) may be formed of any suitable size, shape, and design and is configured to provide an extension feature and/or handling device for the animal toy and for the ability to hang the animal toy from the animal and/or attach the animal toy to the animal.

In the arrangement shown, as one example, a cord/string is used as the extension device 40. However, the string may also be a rope, a telescoping pole, a ball launcher, a leverage ball thrower, a rope, a combination thereof, and the like. The extension device itself may also serve as a toy for the animal as it may be formed of a rope and the like. These and other extension devices are hereby contemplated for use. Furthermore, the system may not require an extension device and may connect directly to the animal, or harness, or collar, or the like.

### Second Attachment Feature

In the arrangement shown as one example, system 10 includes a second attachment feature 50. Second attachment feature 50 (or “device attachment feature”) may be formed of any suitable size, shape, and design and is configured to attach and/or connect the extension device 30 to the animal via a collar and/or harness (to be further discussed herein) and/or another device and/or location and/or to the animal itself.

In the arrangement shown, as one example, the second attachment feature 40 includes a plurality of loops which are permanently attached to one another. In this way, the loops are permanently attached, such that the loops permanently affix the animal toy 20.

In the arrangement shown, as one example, the second attachment feature 50 is formed of a string and/or fabric which is looped to secure the animal toy 20 to the extension device 40 and/or another device such as a collar and/or harness. However, the first attachment feature may also be detachable from the extension device 40 or other devices. In this way, and in this example, the first attachment feature 30 may be formed of varying materials and devices. Varying materials and devices for the formation of the first attachment feature 30 includes both permanent and temporary attachment mechanisms, but are not limited to, hook and loop and buckle configurations, a spring clip, a knot, a clip, a magnet, a coupling, a lobster claw, an egg hook, a key clip, a spring hook, a carbine buckle, a gate snap hook, a swivel hook, a badge clip, a plastic hook, a carabiner, a reel clip, a badge reel, a swivel buckle, a safety buckle, an adjustable buckle, a key ring, any combination thereof, and the like.

### Method of Use/Method of Treatment

As one example, a method of use of an animal toy apparatus is disclosed herein. A method of use includes both a first and second attachment feature. In this way, the first attachment feature attaches and detaches a toy to an extension device, which connects to a second attachment device which may connect to a collar and/or harness or the like.

It will be appreciated by those skilled in the art that other various modifications could be made to the device without parting from the spirit and scope of this disclosure. All such modifications and changes fall within the scope of the claims and are intended to be covered thereby.

What is claimed:

1. A dog toy apparatus, the apparatus comprising:
an engagement device;
the engagement device formed an article of interest to a pet;
the engagement device having a first attachment feature;
wherein the first attachment feature is configured to accept attachment;
an extension device;
the extension device having a second attachment feature;
wherein the second attachment feature is configured to attach to the first attachment feature;
wherein the engagement device can be attached to a third device located on an animal;
wherein the engagement device can be removed from the third device located on an animal.

2. The apparatus of claim 1, further comprising:
wherein the engagement device is a ball.

3. The apparatus of claim 1, further comprising:
wherein the first attachment feature is a small loop;
wherein the extension device is secured to the first attachment feature by tying a knot around the small loop.

4. The apparatus of claim 1, further comprising:
wherein the first attachment feature is a small loop;
wherein the extension device is secured to the first attachment feature by hook and loop engagement when the hook and loop is wrapped through the small loop and engaged.

5. The apparatus of claim 1, further comprising:
wherein the first attachment feature is formed of hook and loop;
wherein the extension device having a hook and loop which engages the hook and loop of the first attachment feature.

6. The apparatus of claim 1, further comprising:
wherein the third device is a collar;
wherein the collar is securely attached to the animal.

7. The apparatus of claim 1, further comprising:
wherein the third device is a harness;
wherein the harness is securely attached to the animal.

8. The apparatus of claim 1, further comprising:
wherein the engagement device glows in the dark.

9. The apparatus of claim 1, further comprising:
a plurality of batteries;
the plurality of batteries providing power to the engagement device.

10. The apparatus of claim 1, further comprising:
a plurality of light emitting diodes;
a plurality of batteries;
wherein the plurality of batteries provide electrical power to the light emitting diodes;
wherein the light emitting diodes are operably connected to the extension device;
a switch;
wherein the switch can be used to activate the light emitting diodes such that the extension device appears with lighting.

11. A dog toy device, comprising:
an engagement device;
the engagement device formed an article of interest to a pet;
the engagement device having a first attachment feature;
wherein the first attachment feature is configured to accept attachment;
an extension device;
the extension device having a second attachment feature;
wherein the second attachment feature is configured to attach to the first attachment feature;
wherein the engagement device can be attached to a third device located on an animal;
wherein the engagement device can be removed from the third device located on an animal.
a plurality of batteries;
wherein the plurality of batteries provide power to the engagement device;
wherein the electrical power from the plurality of batteries causes mechanical movement of the engagement device;
wherein the movement of the engagement devices causes an animal to be engaged.

12. The device of claim 1, further comprising:
wherein the engagement device is a ball.

13. The apparatus of claim 1, further comprising:
wherein the first attachment feature is a small loop;
wherein the extension device is secured to the first attachment feature by tying a knot around the small loop.

14. The apparatus of claim 1, further comprising:
wherein the first attachment feature is a small loop;
wherein the extension device is secured to the first attachment feature by hook and loop engagement when the hook and loop is wrapped through the small loop and engaged.

15. The apparatus of claim 1, further comprising:
wherein the first attachment feature is formed of hook and loop;
wherein the extension device having a hook and loop which engages the hook and loop of the first attachment feature.

16. The apparatus of claim 1, further comprising:
wherein the third device is a collar;
wherein the collar is securely attached to the animal.

17. The apparatus of claim 1, further comprising:
wherein the third device is a harness;
wherein the harness is securely attached to the animal.

18. The apparatus of claim 1, further comprising:
wherein the engagement device glows in the dark.

19. The apparatus of claim 1, further comprising:
a plurality of light emitting diodes;
a plurality of batteries;
wherein the plurality of batteries provide electrical power to the light emitting diodes;
wherein the light emitting diodes are operably connected to the extension device;
a switch;
wherein the switch can be used to activate the light emitting diodes such that the extension device appears with lighting.

20. A method of carrying and using an animal toy, the steps comprising:
providing an animal toy having a first attachment feature;
attaching the animal toy to a first attachment feature of an apparatus attached to an animal;
moving with the animal such that the animal carries the animal toy from a first location to a second location;
removing the animal toy from the first attachment feature;
using the animal toy;
engaging with the animal with the animal toy.
